(19) United States
(12) Patent Application Publication
(10) Pub. No.: US 2007/0278929 A1
(43) Pub. Date: Dec. 6, 2007

(54) Hot Cathode Fluorescent Lamp Without Filament

(75) Inventors: Zhen Liu Chen, Fujian (CN); Zong Lie Chen, Fujian (CN)

Correspondence Address: Raymond Y. Chan, 108 N. Ynez Avenue,, Suite 128, Monterey Park, CA, 91754, US

(73) Assignee: Fujian GPB Enterprises Limited

(21) Appl. No.: 11/578,402

(22) PCT Filed: Apr. 19, 2005
(86) PCT No.: PCT/IB05/01799

§ 371 Date: Oct. 13, 2006

(30) Foreign Application Priority Data
Apr. 20, 2004 (CN) 200410017780.7

(51) Int. Cl. H01J 61/067; H01J 61/36

(52) U.S. Cl. 313/485

(57) ABSTRACT

A hot cathode fluorescent lamp without filament includes a tube having a phosphor layer coated on an inner surface thereof and being filled with an amalgam and an inert gas, two electrodes sealedly provided at two ends of the tube respectively wherein at least one of the electrodes, which is made of metallic anti-evaporation material having a melting point of at least 1500° C., has an oxide layer coated on an outer surface of the electrode, and a peripheral circuit electrically coupled with the electrodes, wherein two outer wires are electrically extended from the electrodes to an exterior of the tube respectively, wherein the tube has an inner operation pressure in a range from 400 to 2600 pascal.

### BACKGROUND OF THE PRESENT INVENTION

1. Field of Invention

The present invention is related to a low pressure gas discharge lamp, more particularly to a hot cathode fluorescent lamp without a filament to improve the illumination and the usage hours.

2. Description of Related Arts

In the state of the art, a low pressure gas discharge lamp with a cathode categorizes into two main classifications: CCFL (cold cathode fluorescent lamp) and hot cathode fluorescent lamp. The CCFL comprises a tube filled with inert gas and mercury vapor, and electrodes provided at two ends of the tube, wherein a fluorescent coating made of metallic and rare-earth phosphor salt are coated on the inner surface of the tube. When a high electric potential difference is applied at the two electrodes on both ends of the tube, electrons are emitted from one of the electrodes and accelerated in the electric field established by the electric potential difference inside the tube. The accelerated electrons with high energy are introduced into the tube to ionize the inert gas to establish an electrical current from one end of the tube to the other end by the ionized gas and electrons, insomuch that the energy of the electrical current changes the state of the mercury from a liquid state to a gas state. The collisions of the mercury gas atoms with the moving electrons and ionized gas excite the mercury gas atoms into the excited mercury atoms, wherein electrons of the mercury atoms jump to a higher energy level so as to release the extra energy in the form of the ultraviolet photons when the excited electrons fall back to their original energy level. The ultraviolet photons at 253.7 nm released by the excited mercury atoms consequently excite the atoms of the fluorescent coating on the inner surface of the tube to boost the electrons of fluorescent coating atoms to a higher energy level so as to release energy in the form of visible light photons when the electrons of fluorescent coating atoms falls back to their original energy level. The CCFL is designed with no filament to provide a simple structure, a bright illumination with low surface heat, and a smaller diameter, which facilitates the manipulation of the fluorescent lamp into all kinds of desired shapes to expend the applicability or decoration purpose. However, the cold cathode fluorescent lamp operates in a form of glow discharge for cold electron emission with the characteristics of low current and high voltage, which suffers the drawbacks of low efficiency and high energy cost that make the CCFL as the public illumination facility impractical and impossible. Furthermore, the requirement of 500 volt for the operation voltage and up to 1000 to 10000 volt for ignition startup voltage due to the high pressure inside the tube, around 2600 to 14000 pascal, demands a transformer with leakage inductance or a electronic transformer to raise the voltage level with the tradeoff of massive volume and low efficiency if the transformer with leakage inductance is adapted, or suffering the electromagnetic interference on the circuit with high manufacture cost if the electronic transformer is adapted. The second common design for the gas discharge lamp is the hot cathode fluorescent lamp, which comprises a tube filled with inert gas and mercury vapor, electrodes, filaments and a peripheral circuit. Similar to the CCFL, a fluorescent coating made of varying blends of metallic and rare-earth phosphor salt are coated on the inner surface of the tube and the filaments are formed as the electrodes and provided at two ends of the tube to function as the electrodes. The peripheral circuit is embodied as a starter and an inductive ballast or an electronic ballast. While the ballast could be, and occasionally is, as simple as a resistor, substantial power is wasted in the resistor ballast. Therefore, ballasts usually facilitate a reactance, either an inductor or a capacitor instead. For operation from main voltage, the use of simple inductor such as the magnetic ballast is common. In countries which use 120 volt AC, the main voltage is insufficient to trigger the large fluorescent lamps. Consequently, the ballast for these larger fluorescent lamps is often a step-up autotransformer with substantial leakage inductance so as to limit the current flow. Either form of inductive ballast may also include a capacitor for power factor correction. More sophisticated ballasts may employ transistors or other semiconductor components to convert mains voltage into high-frequency AC while also regulating the current flow in the lamp. These are referred to as “electronic ballasts”. The mercury atoms in the fluorescent tube must be ionized before the arc can strike within the tube. For small lamps, it does not take much voltage to strike the arc and starting the lamp presents no problem, but larger tubes require a substantial voltage, in the range of a thousand volts. A well-know fluorescent design used a combination filament/cathode at each end of the lamp combined with a mechanical or automatic switch that would initially connect the filaments in series and thereby preheat the filaments prior to striking the arc. Because of thermionic emission, the filaments would readily emit electrons into the gas column creating an arc discharge near the filaments. Then, when the starting switch opened up, the inductive ballast would create a voltage surge which would usually strike the arc. If so, the impinging arc then kept the filament/cathode warm. If not, the starting sequence was repeated. If the starting aid was automatic, this often led to the situation where an old fluorescent lamp would flash time and time again as the starter repeatedly tried to start the worn-out lamp. Newer lamp and ballast designs, known as rapid start lamps, provide true filament windings within the ballast; these rapidly and continuously warm the filaments/cathodes using low-voltage AC. Unfortunately, there is no inductive voltage surge produced so the lamps must usually be mounted near a grounded reflector to allow the glow discharge to propagate through the tube and initiate the arc discharge. Electronic ballasts often revert to a style in-between the preheat style and the rapid-start style: a capacitor or other electronic circuit may join the two filaments, providing a conduction path that preheats the filaments but which is subsequently shorted out by the arc discharge. Even though the hot cathode fluorescent lamp facilitates the arc discharge to initiate the lighting process of the fluorescent lamp which is more efficient as compared with the glow discharge in the CCFL, however, the limitation is opposed on the manufacture and design of the hot cathode fluorescent lamp due to the assemblage of the filament inside the tube. In the well-developed manufacture technology, the most common hot cathode fluorescent lamp is designed in the diameter of 12 mm or larger while the low-watt (under 15 watt) compact hot cathode fluorescent lamp under the 9 mm to 10 mm diameter would suffers the filament spitter problem and black heads on both ends of the tube where the filaments are adapted after a usage of half year or 1000 times on-off switching experiment. Only less than 7 watt of hot cathode fluorescent lamp would suffice the restrictions on the ultra slim lamp design of the fluorescent lamp having a diameter smaller than 9 mm. The drawbacks of the hot cathode fluorescent lamp are, for example, poor performance of on-off switching capability, the thermal effect on the peripheral circuit causing unstable preheat current, time constant shifting and the change in LC oscillation frequency, let alone the possible damage on the filament inside the tube due to the mishandling during the transportation of the fluorescent lamp, resulting the breakage of the usage hours of the fluorescent lamp. Another disadvantage should be taken into consideration is the metallurgical industrial technology, causing the unbalance thickness of the tungsten filament during the manufacture, wherein the preheat current may cause the filament disconnected due to the atom migration when the mismatching filaments are under the process of establishing arc discharge. Furthermore, the vaporization of the heated filament would also generate CO and CO₂ gas inside the tube and the only way to control the rate of exhaust pipe to discharge the waste gas is based on the experience to manually manipulate, hardly to establish a reliable and consistent control mechanism.

### SUMMARY OF THE PRESENT INVENTION

The main object of the present invention is to solve the problems arose by this two main classifications of gas discharge lamp: the cold cathode fluorescent lamp operates in a form of glow discharge for cold electron emission with the characteristics of low current and high voltage, which suffers the drawbacks of low efficiency and high energy cost that make the CCFL as the public illumination facility impractical and impossible. Furthermore, the requirement of 500 volt for the operation voltage and up to 1000 to 10000 volt for ignition startup voltage due to the high pressure inside the tube, around 2600 to 14000 pascal, demands a transformer with leakage inductance or a electronic transformer to raise the voltage level with the tradeoff of massive volume and low efficiency if the transformer with leakage inductance is adapted, or suffering the electromagnetic interference on the circuit with high manufacture cost if the electronic transformer is adapted; the limitation is opposed on the manufacture and design of the hot cathode fluorescent lamp due to the assemblage of the filament inside the tube. In the well-developed manufacture technology, the most common hot cathode fluorescent lamp is designed in the diameter of 12 mm while the low-watt (under 15 watt) compact hot cathode fluorescent lamp under the 9 mm to 10 mm diameter would suffers the filament spitter problem and black heads on both ends of the tube where the filaments are adapted after a usage of half year or 1000 times on-off switching experiment. Only less than 7 watt of hot cathode fluorescent lamp would suffice the restrictions on the ultra slim lamp design. The drawbacks of the hot cathode fluorescent lamp are, for example, poor performance of on-off switching capability, the thermal effect on the peripheral circuit causing unstable preheat current, time constant shifting and the change in LC oscillation frequency, let alone the possible damage on the filament inside the tube due to the mishandling during the transportation of the fluorescent lamp, resulting the breakage of the usage hours of the fluorescent lamp. Another disadvantage should be taken into consideration is the metallurgical industrial technology, causing the unbalance thickness of the tungsten filament during the manufacture, wherein the preheat current may cause the filament disconnected due to the atom migration when the mismatching filaments are under the process of establishing arc discharge. Furthermore, the vaporization of the heated filament would also generate CO and CO₂ gas inside the tube and the only way to control the rate of exhaust pipe to discharge the waste gas is based on the experience to manually manipulate, hardly to establish a reliable and consistent control mechanism.

In order to accomplish the above object, the present invention provides a hot cathode fluorescent lamp with no filament, which comprises a tube, a pair of electrodes and a peripheral circuit, wherein the pair of electrodes are adapted inside the tube through the sealing entrances at both ends of the tube, respectively, while the phosphor is coated on the inner surface of the tube and the amalgam and the inert gas are injected into the tube, along with the peripheral circuit connecting to the pair of electrodes by the connection wire and the sealing entrance adapting the stem sealing technology or the non-filament clip-sealing technology to implement the sealing. Each of the electrodes is connected to at least one outer wire of which the other end is adapted outside the tube with the metallic anti-evaporation nature and the melting point of at least 1500 centigrade as the choice of the material for the electrodes, and is coated with a oxide layer above the surface of the electrode, operating in the pressure of 400 to 2600 pascal inside the tube. In more specific, the two electrodes at the tube function as the cathodes.

Furthermore, the metallic anti-evaporation material is tungsten, tungsten-rhenium alloy, or tungsten-thorium alloy.

Furthermore, the oxide layer above the electrode is a mixture product of the carbonate and the zirconia, facilitating the vacuum heat-vaporizing technique to coat on the electrode before sealing the tube.

Furthermore, the oxide layer above the electrode is a mixture product of the carbonate and the zirconia, facilitating the vacuum heat-vaporizing technique to coat on the electrode before sealing the tube under the temperature of 900 centigrade.

Furthermore, the electrode is adapted the coil metallic wire to wind or clip on a metallic inner wire, wherein the metallic inner wire is designed as the straight shape to adapt one end of the metallic inner wire inside the tube and the other at the sealing entrance. In more specific, the electrode inside the tube is functioned as the cathode.

Furthermore, the pair of the outer wires is connected to a capacitor at each of the outer end to establish a parallel connection between the peripheral circuit and the capacitor/tube.

Furthermore, the electrode is adapted with two coil metallic wires into a crotched shape so that two metallic inner wires are designed in a crotched shape where each of the coil metallic wires are either wind or clip on one end of each of the metallic inner wires, respectively, whereas one end of the metallic inner wire with the coil metallic wire affixed is inside the tube while the other end of the metallic inner wire is at the sealing entrance. In more specific, the electrode inside the tube is functioned as the cathode.

Furthermore, the coil metallic wire is adapted with either double-coil wire or triple-coil wire.

As a comparison with the prior art, the present invention has a phenomenal and obvious improvement in the design of the fluorescent lamp structure. The design of the metallic anti-evaporation material as the electrode and the oxide layer above the electrode improves the heat-resistance and the resistance against the impact between the ionized atoms and the electrode, in the meanwhile also enhance the ability of hot electron emission. Furthermore, the electrode is adapted with the single or multiple coil metallic wires affixed on the metallic inner wires based on the different demands on power and illumination, inasmuch as the different electrodes may function by turns as the cathodes to prevent the black head on each ends of the tube and increase the usage hours of the electrodes; moreover, the capacitor is parallelly connected to the bulb so as to reserve the energy connecting to the LC oscillator network to offer a higher operating voltage on the bulb. The present invention is designed with simple structure, easy manufacture, and stable quality control to apply into all shapes and lengths of fluorescent lamps, proving to have a better illumination and longer usage hours up to 20% to 100% in comparison with the cold cathode fluorescent lamp, and also preventing the filament spitter and the black head on the end of the tube in comparison with the hot cathode fluorescent lamp with filament.

### BRIEF DESCRIPTION OF THE DRAWINGS

FIG. 1 is a circuit diagram of the hot cathode fluorescent lamp without filament according to a preferred embodiment of the present invention.

FIG. 2 is a partially perspective view of the electrodes of the hot cathode fluorescent lamp without filament according to the above preferred embodiment of the present invention.

FIG. 3 is a partially perspective view of the crotched electrodes of the hot cathode fluorescent lamp without filament according to the above preferred embodiment of the present invention.

### DETAILED DESCRIPTION OF THE PREFERRED EMBODIMENT

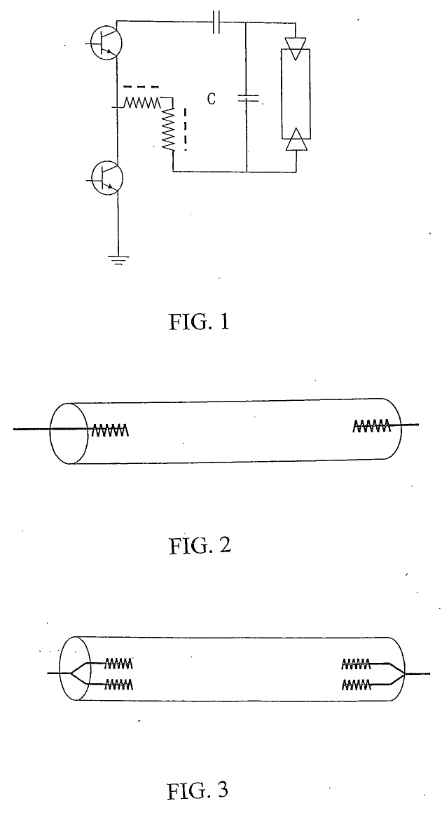

Referring to FIG. 1 to FIG. 3, the hot cathode fluorescent lamp without filament is illustrated. According to the preferred embodiment, the hot cathode fluorescent lamp without filament comprises a tube, two electrodes and a peripheral circuit. The two electrodes are sealedly mounted at two ends of the tube at two sealing openings respectively. A phosphor layer is coated on the inner surface of the tube and an amalgam and an inert gas are injected into the tube. The peripheral circuit is electrically connected to the two electrodes by the connection wire and also the sealing entrance adapting a stem sealing technology or a non-filament clip-sealing technology to implement the sealing. Two outer wires are electrically extended from the electrodes to an exterior of the tube respectively. At least one of the electrodes, which is made of metallic anti-evaporation material having a melting point of at least 1500° C., has an oxide layer coated on an outer surface of the respective electrode. The tube has an inner operation pressure in a range from 400 to 2600 pascal. In more specific, the two electrodes at the tube function as the cathodes and the pressure inside the tube is 1068 pascal according to the preferred embodiment of the present invention.

Furthermore, the metallic anti-evaporation material of the electrode is selected from the group consisting of tungsten, tungsten-rhenium alloy, and tungsten-thorium alloy.

Furthermore, the oxide layer is a mixture of the carbonate and the zirconia to sealedly coat on the electrode before sealing the tube through the vacuum heat-vaporizing technique.

Furthermore, the mixture of carbonate the zirconia to form the oxide layer is made by the vacuum heat-vaporizing technique to coat on the electrode before sealing the tube under the temperature of 900° C., wherein the electrode is arranged to be excited at low-temperature. The first step is to collect and arranged all the electrodes inside a quartz-made tube with two pipeline inlets on the top of the tube, in which one of the pipeline inlets is connected to the vacuum bumper while the other is connected to the pure argon gas for stand by. The second step is to arrange the tube with electrodes into a heating coil of a high frequency furnace to completely decompose the electrodes by high temperature heat, injecting the argon gas to cleanse, at the average temperature of 900° C. in the heating coil of the high frequency furnace. The third step is to increase the temperature to ensure the electrodes completely excited.

Furthermore, the electrode comprises a coil metallic wire mounted to a metallic inner wire having an elongated structure that one end of the metallic inner wire is disposed within the tube while another opposed end is sealed within the sealing opening of the tube. Accordingly, the coil metallic wire is arranged to wind or clip on the metallic inner wire. In more specific, the electrode inside the tube is functioned as the cathode.

Furthermore, the two outer wires are connected to a capacitor at each of the outer end of the tube wherein the tube and the capacitor are electrically coupled with the peripheral circuit in a parallel connection.

Furthermore, the electrode is a Y-shaped bifurcated electrode comprising at least two spiral metal wires, wherein the tube comprises at least two metallic inner wires sealedly mounted within the tube at the sealing opening thereof and securely mounted to the spiral metal wires respectively. Accordingly, each of the spiral metal wires is arranged to wind or clip on one end of each of the metallic inner wires. One end of the metallic inner wire with the spiral metal wire is affixed inside the tube while the other end of the metallic inner wire is mounted at the sealing opening. In more specific, the electrode inside the tube is functioned as the cathode.

Furthermore, the spiral metal wire is embodied as one of a double-coiled wire and a triple-coiled wire.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A hot cathode fluorescent lamp, comprising:
a tube having a phosphor layer coated on an inner surface thereof and being filled with an amalgam and an inert gas, two electrodes sealedly provided at two ends of said tube respectively wherein at least one of said electrodes, which is made of metallic anti-evaporation material having a melting point of at least 1500° C., has an oxide layer coated on an outer surface of said electrode, and a peripheral circuit electrically coupled with said electrodes, wherein two outer wires are electrically extended from said electrodes to an exterior of said tube respectively, wherein said tube has an inner operation pressure in a range from 400 to 2600 pascal.

2. The hot cathode fluorescent lamp, as recited in claim 1, wherein said metallic anti-evaporation material of said electrode is selected from the group consisting of tungsten, tungsten-rhenium alloy and tungsten-thorium alloy.

3. The hot cathode fluorescent lamp, as recited in claim 1, wherein said oxide layer is made a mixture of carbonate and zirconia to sealedly coat on said electrode through a vacuum heat-vaporizing technique.

4. The hot cathode fluorescent lamp, as recited in claim 3, wherein said oxide layer is made by said vacuum heat-vaporizing technique to coat on said electrode before sealing said tube under the temperature of 900° C.

5. The hot cathode fluorescent lamp, as recited in claim 1, wherein said electrode comprises a coil metallic wire mounted to a metallic inner wire having an elongated structure that one end of said metallic inner wire is disposed within said tube while another opposed end is sealed within a sealing opening of said tube.

6. The hot cathode fluorescent lamp, as recited in claim 1, further comprising a capacitor electrically coupled between said two outer wires, wherein said capacitor and said tube are electrically coupled with said peripheral circuit in a parallel connection.

7. The hot cathode fluorescent lamp, as recited in claim 1, wherein said electrode is a Y-shaped bifurcated electrode comprising at least two spiral metal wires, wherein said tube comprises at least two metallic inner wires sealedly mounted within said tube at a sealing opening thereof and securely mounted to said spiral metal wires respectively.

8. The hot cathode fluorescent lamp, as recited in claim 5, wherein said spiral metal wire is embodied as one of a double-coiled wire and a triple-coiled wire.

9. The hot cathode fluorescent lamp, as recited in claim 7, wherein said spiral metal wire is embodied as one of a double-coiled wire and a triple-coiled wire.
